(19) United States
(12) Patent Application Publication
(10) Pub. No.: US 2017/0025046 A1
(43) Pub. Date: Jan. 26, 2017

(54) ELECTRICIANS WIRE LABELLING SYSTEM

(71) Applicant: Jeremy Butts, Waco, TX (US)

(72) Inventor: Jeremy Butts, Waco, TX (US)

(21) Appl. No.: 15/211,174

(22) Filed: Jul. 15, 2016

Related U.S. Application Data
(60) Provisional application No. 62/195,236, filed on Jul. 21, 2015.

(51) Int. Cl. G09F 3/10; H01B 7/36; G09F 3/02

(52) U.S. Cl. CPC G09F 3/10; G09F 3/02; H01B 7/365; G09F 2003/0201; G09F 2003/0226

(57) ABSTRACT

The present invention includes a system for marking a plurality of wires connected to a 3 phase electric distribution system that includes a plurality of preprinted self-adhesive labels for use on electrical wires wherein each of the labels in the plurality of labels bears one of first, second and third unique indicia and a preprinted unique integer number.

### CROSS-REFERENCE TO RELATED APPLICATIONS

The present application has priority based on provisional U.S. patent application 62/195,236 filed on Jul. 21, 2015 having the applicant. That application is hereby incorporated herein by reference in its entirety.

### TECHNICAL FIELD

The present invention is generally directed to electrical wiring and the labels used for labeling of electrical wires during electrical wiring of commercial and residential buildings and other structures.

### BACKGROUND OF THE INVENTION

Electric power generation commonly involves the generation of alternating current (AC) that is generated at a power generation facility and transmitted to commercial and residential buildings and other structures in three phases. Such a “three-phase system” involves generation of three separate, generally sinusoidal electrical voltages that have approximately the same frequency and voltage amplitude, but the three sinusoidal waves are offset from each other by a phase difference of one-third of the total period (2π/3). The three phases of power are carried from the electrical generation facility to commercial and residential buildings and other structures on three separate wires. Commercial and residential buildings often contain a variety of loads that are powered by one phase or two phases, and occasionally loads may run off of all three phases of power. It is important when making wiring connections to the various loads inside a structure to identify and distinguish between the various lines and the phases that are wired from the main fuse box throughout the building to the various loads in various locations within the building.

In the building and construction trades, electricians commonly work with both three-phase low voltage wires and three-phase high voltage wires. In the United States, the low voltage wires are 120V/240V or 120V/208V wires, but the low voltage wires may carry different voltage amplitudes in other countries. The three phases of power are carried on three separate low voltage wires which have three different color insulators. The three different insulator colors for the respective wires are used so that the three phases of the low voltage power supply can be differentiated from each other. In the United States, it is common for the black, red, and blue colored insulation to be used on the low voltage wires in order to distinguish between the three phases of low voltage power being supplied. The black, red, and blue wires represent the three separate phases of low voltage power that are supplied. The wire distinguishing between the three phases will vary from country to country.

Similarly, high voltage power is also supplied in three phases. In the United States, high voltage power is carried on 277V/480V wire. The voltage amplitudes carried on high voltage wires will vary from country to country. As with the low voltage wires, high voltage wires carry three phases of power and it is necessary to distinguish between the three phases of power that are supplied. As with low voltage, the three phases of high voltage power are carried on three separate high voltage wires that remain distinguishable from each other because they have three different wire insulator colors. While the colors of wire used to distinguish the three phases of high voltage power may vary from country to country, in the United States the three commonly used wire colors used to distinguish the three phases of high voltage power are brown, orange, and yellow. The brown, orange, and yellow wires represent the three separate phases of the high voltage power supply. The wire colors used to distinguish between the three phases will vary from country to country.

Electricians working in commercial and residential construction are typically provided with electrical wiring diagrams or schematics known as “prints” that show the plan for how to wire various rooms or sections of a building or structure. The prints are a wiring diagram showing the different wires that should be used to connect a main fuse box or other connection point in a first location to certain loads or additional boxes in a second location within the building or structure. For example, a print might specify which connection points in a fuse box at a first location should be connected to which outlets, light fixtures, fans, motors, boxes or other connection points located in a second location. Part of an electrician's job when wiring from one location to another location inside a commercial or residential building or other structure is to read the print and use it to determine the appropriate wires that should be pulled through conduit from either the first location to make a connection at connection points in the second location, or vice versa. When the wires have been appropriately pulled through the conduit, the wire can be attached to the connection points on the fuse box and can be connected to the boxes or loads such as outlets, fixtures, fans, motors, etc. at the second location. This is the basic process for wiring various sections of a building or other structure.

The electrical wiring process can become relatively confusing when connections are made from a fuse box or other connection point at a first location to boxes or loads located at a second location in a commercial or residential building or other structure because there can be multiple wires, sometimes even hundreds of wires, and it is important to connect the right wires carrying the right voltage phases from one location to another location. This has traditionally been accomplished by simply labeling the various wires with numbers that correspond to connection points in a main fuse box or remote box. The most common method of labeling the three phase wires involves labeling the wires numerically by labeling the first phase wire with an adhesive label printed with the number “1” that is adhered to the outside of the wire before it is run through the conduit from the first location to the second location, labeling the second phase wire with an adhesive label printed with the number “3” that is adhered to the second phase wire which is run through the conduit from the first location to the second location, and a third phase wire with an adhesive label printed with the number “5” that is adhered to the third phase wire that is run from the first location to the second location. In a low voltage setting in the United States, these three numbered labels will correspond to three different colors of wire carrying the three phases of power, i.e., the “1” label will be used to label black wire, the “3” label will be used to label red wire, and the “5” will be used to label blue wire. The next set of three-phase wires will be labeled with the first phase wire being labeled with a label marked with the number “2”, the second phase wire will be labeled with a label marked with the number “4” and the third phase wire will be labeled with a label marked with the number “6”. Again, in the United States in a low voltage setting the “2” label will be placed on black wire, the “4” label will be placed on red wire, and the “6” will be placed on blue wire. This process is repeated such that labels printed with the numbers “7”, “9” and “11” are used to label the next set of black, red, and blue wire three-phase wires, and labels with printed numbers “8”, “10” and “12” will be used to label the subsequent set of black, red, and blue three phase wires. This process is carried on for all of the wiring in the building.

When an initial labeled length of wire is pulled through conduit from a first location to a second location and a second length of wire is needed to make a connection to the initial labeled wire when it emerges from the conduit at the second location, it is imperative that the electrician must use a second length of wire that is the same color as the initial labeled wire to which the second length of wire is to be connected. In practice the way that this typically occurs is that the electrician will look at and try to remember the number on the initial labeled length of wire that has been pulled through the conduit from the first location to the second location and will then go to a wire cart or wire spool and unroll and cut a second length of wire that will be used to make a connection to the initial labeled length of wire at the second location. Sometimes the electrician will write down the number on the label attached to the initial labeled wire before he goes to the wire cart or wire spool to obtain a second length of wire.

When using the above-described method involving labels bearing printed numbers, confusion resulting in wiring mistakes often occurs, especially when there are a large number of wires being pulled through conduit from a first location to a second location. Although the initial labeled wires pulled through the conduit from the first location to the second location are labeled with labels bearing the numbers that correspond to specific wire colors, the electrician is forced to mentally keep track of the numbers and how they correspond to the wire colors that are being used. While it may not be difficult to remember that a wire label bearing number “1” corresponds to a black phase wire in a low voltage system or a brown phase wire in a high voltage system, it is not always easy to remember that a wire label bearing number “43” corresponds to a black phase wire in a low voltage system or a brown phase wire in a high voltage system. Moreover, when there are multiple initial labeled wires pulled from a first location through conduit to a second location and connections need to the made at the second location, the multiple numeric labels for the wires can result in confusion regarding which color wire must be obtained for use making connections at the second location. For example, an electrician could easily be presented with a situation where wires bearing labels with “9”, “28”, and “39” are emerging from the conduit at the second location, and it is not easy to remember that each of these corresponds to an orange phase wire in a high voltage setting or a red phase wire in a low voltage setting. Thus, when an electrician goes to a wire cart or wire spool to select the next section of wire to be pulled through conduit to make a connection at a second location, the electrician will often remember the number(s) but not the corresponding colors of wire to be pulled and must engage in some quantum of thinking. Although experienced electricians will pull the right color phase wire the majority of the time, a significant number of mistakes are made which results in waste of material, time, effort, and money. The mistakes are often compounded as the actual quantity of wires pulled through a section of conduit are increased and as the numbers on the adhesive labels attached to the wires grow higher, both of which can contribute to simple miscalculations that cause the wrong color of wire to be obtained and pulled through the next section of conduit resulting in wasted time and effort and unusable wire that is removed and trashed.

Up to this time, nobody has formulated a method or a product that substantially eliminates the confusion inherent in electricians on construction sites pulling three phases of wire during electrical wiring jobs wherein there are multiple wires with a large quantity of numerically marked labels bearing numbers that correspond to different phases of wire being used.

The electrical wiring process can become relatively confusing when connections are made from a fuse box or other connection point at a first location to boxes or loads located at a second location in a commercial or residential building or other structure because there can be multiple wires, sometimes even hundreds of wires, and it is important to connect the right wires carrying the right voltage phases from one location to another location. This has traditionally been accomplished by simply labeling the various wires with numbers that correspond to connection points in a main fuse box or remote box. The most common method of labeling the three phase wires involves labeling the wires numerically by labeling the first phase wire with an adhesive label printed with the number “1” that is adhered to the outside of the wire before it is run through the conduit from the first location to the second location, labeling the second phase wire with an adhesive label printed with the number “3” that is adhered to the second phase wire which is run through the conduit from the first location to the second location, and a third phase wire with an adhesive label printed with the number “5” that is adhered to the third phase wire that is run from the first location to the second location. In a low voltage setting in the United States, these three numbered labels will correspond to three different colors of wire carrying the three phases of power, i.e., the “1” label will be used to label black wire, the “3” label will be used to label red wire, and the “5” will be used to label blue wire. The next set of three-phase wires will be labeled with the first phase wire being labeled with a label marked with the number “2”, the second phase wire will be labeled with a label marked with the number “4” and the third phase wire will be labeled with a label marked with the number “6”. Again, in the United States in a low voltage setting the “2” label will be placed on black wire, the “4” label will be placed on red wire, and the “6” will be placed on blue wire. This process is repeated such that labels printed with the numbers “7”, “9” and “11” are used to label the next set of black, red, and blue wire three-phase wires, and labels with printed numbers “8”, “10” and “12” will be used to label the subsequent set of black, red, and blue three phase wires. This process is carried on for all of the wiring in the building.

When an initial labeled length of wire is pulled through conduit from a first location to a second location and a second length of wire is needed to make a connection to the initial labeled wire when it emerges from the conduit at the second location, it is imperative that the electrician must use a second length of wire that is the same color as the initial labeled wire to which the second length of wire is to be connected. In practice the way that this typically occurs is that the electrician will look at and try to remember the number on the initial labeled length of wire that has been pulled through the conduit from the first location to the second location and will then go to a wire cart or wire spool and unroll and cut a second length of wire that will be used to make a connection to the initial labeled length of wire at the second location. Sometimes the electrician will write down the number on the label attached to the initial labeled wire before he goes to the wire cart or wire spool to obtain a second length of wire.

When using the above-described method involving labels bearing printed numbers, confusion resulting in wiring mistakes often occurs, especially when there are a large number of wires being pulled through conduit from a first location to a second location. Although the initial labeled wires pulled through the conduit from the first location to the second location are labeled with labels bearing the numbers that correspond to specific wire colors, the electrician is forced to mentally keep track of the numbers and how they correspond to the wire colors that are being used. While it may not be difficult to remember that a wire label bearing number “1” corresponds to a black phase wire in a low voltage system or a brown phase wire in a high voltage system, it is not always easy to remember that a wire label bearing number “43” corresponds to a black phase wire in a low voltage system or a brown phase wire in a high voltage system. Moreover, when multiple initial labeled wires are pulled from a first location through conduit to a second location and connections need to the made at the second location, the multiple numeric labels for the wires can result in confusion regarding which color wire must be obtained for use making connections at the second location. For example, an electrician could easily be presented with a situation where wires respectively bearing labels with “9”, “28”, and “39” are emerging from the conduit at the second location, and it is not easy to remember that each of these corresponds to an orange phase wire in a high voltage setting or a red phase wire in a low voltage setting. Thus, when an electrician goes to a wire cart or wire spool to select the next section of wire to be pulled through conduit to make a connection at a second location, the electrician will often remember the number(s) but not the corresponding colors of wire to be pulled and must engage in some quantum of thinking. Although experienced electricians will pull the right color phase wire the majority of the time, a significant number of mistakes are made which results in waste of material, time, effort, and money. The mistakes are often compounded as the actual quantity of wires pulled through a section of conduit are increased and as the numbers on the adhesive labels attached to the wires grow higher, both of which can contribute to simple miscalculations that cause the wrong color of wire to be obtained and pulled through the next section of conduit resulting in wasted time and effort and unusable wire that is removed and trashed.

From the above, it is therefore seen that there exists a need in the art to overcome the deficiencies and limitations described herein and above.

### SUMMARY OF THE INVENTION

The present invention includes a system for marking a plurality of wires connected to a 3 phase electric distribution system that includes a plurality of preprinted self-adhesive labels for use on electrical wires wherein each of the labels in the plurality of labels bears one of first, second and third unique indicia and a preprinted unique integer number.

The system for a 3 phase electric distribution system is a low voltage system may include preprinted adhesive labels that include respective preprinted unique integer numbers “1”, “2”, “7”, “8”, “13”, “14”, “19”, “20”, “25”, “26”, “31”, “32”, “37”, “38”, “43”, and “44” and the unique indicia is black and/or preprinted adhesive labels that include respective preprinted unique integer numbers “3”, “4”, “9”, “10”, “15”, “16”, “21”, “22”, “27”, “28”, “33”, “34”, “39”, “40”, and “45” and the unique indicia is red and/or respective preprinted unique integer numbers “5”, “6”, “11”, “12”, “17”, “18”, “23”, “24”, “29”, “30”, “35”, “36”, “41”, and “42” and the unique indicia is blue.

The system for a 3 phase electric distribution system a high voltage system may include preprinted adhesive labels that include respective preprinted unique integer numbers “1”, “2”, “7”, “8”, “13”, “14”, “19”, “20”, “25”, “26”, “31”, “32”, “37”, “38”, “43”, and “44” and the unique indicia is brown and/or respective preprinted unique integer numbers “3”, “4”, “9”, “10”, “15”, “16”, “21”, “22”, “27”, “28”, “33”, “34”, “39”, “40”, and “45” will and the unique indicia is orange and/or preprinted adhesive labels include respective preprinted unique integer numbers “5”, “6”, “11”, “12”, “17”, “18”, “23”, “24”, “29”, “30”, “35”, “36”, “41”, and “42” and the unique indicia is yellow.

The present invention also includes the method for distinguishing between multiple wires carrying three-phase power in which the wires carrying power come in three separate colors that distinguish between the three separate phases of power that will be carried on the wires and adhesive labels bearing numbers printed in the same colors as the wires to which they are to be affixed are used to label the wires in order to keep track of each wire by number in relation to its connection to the main fuse box and also in order to distinguish between the phases of power.

The method also includes tracking multiple wires in a three-phase power system in which the colored wires used in a three-phase system are labeled with preprinted adhesive labels that bear a number corresponding to the number of the wire reflected in a wiring plan and each of the adhesive labels also comes pre-marked with the color of the wire to which it will be affixed.

The present invention is directed to preprinted adhesive labels used by electricians to mark wires during the wiring of commercial and residential buildings and other structures. The present invention encompasses both a product and a method of labeling wires to avoid confusion during the wiring of commercial and residential buildings and other structures. Preprinted adhesive labels used for marking wire are known in the art. The present invention is an improvement on prior preprinted adhesive labels because it uses the addition of color to the preprinted adhesive labels wherein the added color corresponds to the colors of the wires on which the preprinted labels will later be adhered during the wiring process and thereby aides electricians in keeping the various wires and the various phases of supplied power separate and distinguishable from each other and aides in pulling the correct color of wire from a wire cart or wire spool when additional wire is needed for making a connection. Adhesive preprinted labels bearing the color of the wires on which they are intended to be used as labels greatly reduces the likelihood of confusion in the wiring process and makes it much less likely that expensive and time-consuming mistakes will be made by electricians when pulling wire on the job.

Accordingly, it is an object of the present invention to provide labels for wiring systems having multiple phases where the labels are preprinted in sets having clearly apparent visually visual indications of the relevant phase as well as sequential unique numbers on respective labels.

It is another object of the present invention to utilize preprinted sets of labels which minimize the risk of duplication of any specific phase and number because the set of preprinted adhesive labels has no duplications and thus prevents inadvertent duplications.

It is yet another object of the present invention to reduce waste of time and material inherent in mistakes including connection of wires with improper installation color coding, improper connections between daisy chained wires.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a front view of a sheet of preprinted adhesive labels showing a common arrangement of preprinted labels in accordance with one of the present invention,

FIG. 2 is a front view of a sheet of preprinted adhesive labels showing a common arrangement of preprinted labels with additional markings on each label to designate the color scheme to be added to the labels,

FIGS. 3A and 3B are respective front views of individual preprinted adhesive labels in accordance with one form of the present invention,

FIGS. 3C and 3D are respective side views of two wires with adhesive labels attached showing the relation between colorized wire labels and the color of the wires to which the colorized wire labels are attached,

FIG. 3E is a front view of a sheet of preprinted labels in accordance with another embodiment of the present invention,

FIG. 4 is a front view of a sheet of preprinted labels in accordance with another embodiment of the present invention for potential use on low voltage three-phase wires in the United States,

FIG. 5 is a front view of a sheet of preprinted labels in accordance with another embodiment of the present invention for potential use on high voltage three-phase wires in the United States,

FIG. 6 is a schematic side view of an individual preprinted labels and an associated piece of release paper.

### DESCRIPTION OF PREFERRED EMBODIMENTS

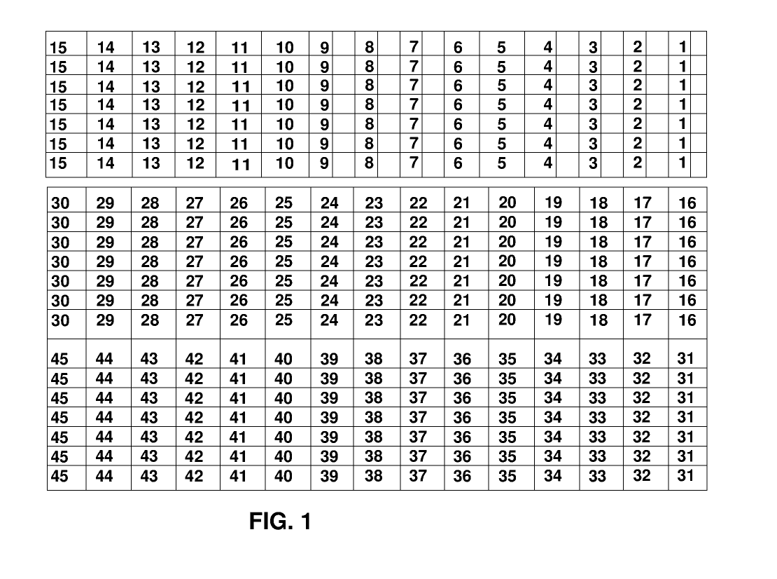

FIG. 1 shows a common sheet of preprinted labels used for the labeling of wires during the wiring of a commercial or residential building or other structure. Each of the rectangular “boxes” that appears with a number printed inside the “box” is a preprinted label that has an adhesive layer on its backside that is further attached to an underlying release film (not visible in FIG. 1). When a label is used, the adhesive backside of the label is pulled away from the underlying release film and the adhesive backside of the label is then adhered to the outer layer of the colored insulation of the wire that is being labeled.

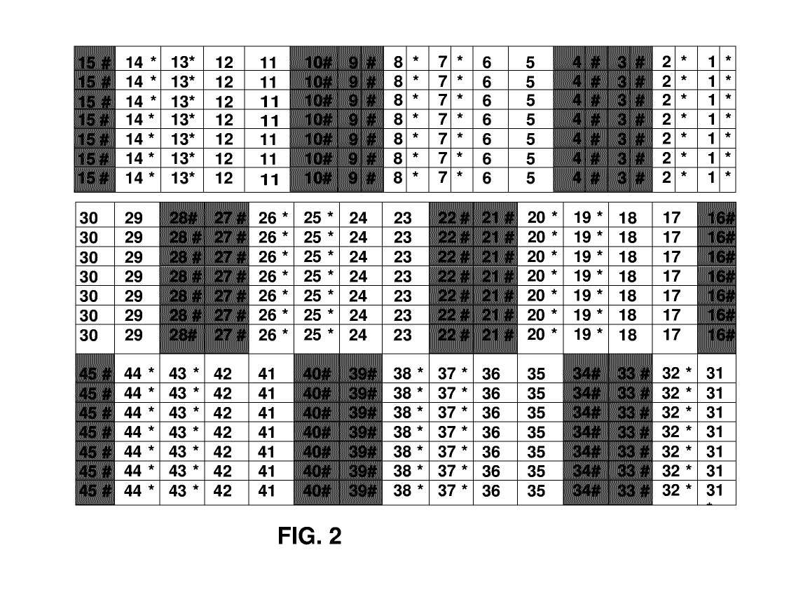

FIG. 2 shows a sheet of preprinted labels substantially the same as the sheet of preprinted labels shown in FIG. 1 except that a symbol has been placed to the immediate right of each of the printed numbers that appear on each of the labels. The symbols shown in FIG. 2 would not necessarily actually appear on the labels themselves, but the symbols have been added to the individual labels shown in FIG. 2 in order to demonstrate the pattern in which each of the labels will be marked or otherwise colorized as part of the practice of the present invention. For instance, each of the labels bearing an asterisk symbol “*” is a label that is intended to be placed on one specific color of wire, each of the labels bearing a pound sign “#” is a label that is intended to be placed on a second specific color of wire, and each of the labels bearing an exclamation mark “!” is a label that is intended to be placed on a third specific color of wire, where the three colors of wire identify the three phases of power being supplied.

With reference to FIG. 2, in one embodiment of the present invention, each of the labels marked with an asterisk symbol“*” has a number that is printed in the same color as the wire on which it will be used as a label, each of the labels marked with a pound sign “#” has a number printed in the same color as the wire on which it will be used as a label, and each of the labels marked with an exclamation mark “!” has a number printed in the same color as the wire on which it will be used as a label. For instance, in a low voltage setting in the United States, all of the individual labels marked with an asterisk mark “*”, in FIG. 2 has a number printed in black ink, all of the individual labels marked with a pound sign “#” in FIG. 2 has numbers printed in red ink, and all of the individual labels marked with an exclamation mark “!” in FIG. 2 has numbers printed in blue ink. As an additional example, in a high voltage setting in the United States, all of the individual labels marked with an asterisk mark “*” in FIG. 2 has a number printed in brown ink, all of the individual labels marked with a pound sign “#” in FIG. 2 has numbers printed in orange ink, and all of the individual labels marked with an exclamation mark “!” in FIG. 2 has numbers printed in yellow ink.

With reference to FIG. 2, in another embodiment of the invention, each of the labels marked with an asterisk symbol “*” will be shaded or highlighted in the same color as the wire on which it will be used as a label, each of the labels marked with a pound sign “#” is shaded or highlighted in the same color as the wire on which it will be used as a label, and each of the labels marked with an exclamation mark IX is shaded or highlighted in the same color as the wire on which it will be used as a label. For instance, in a low voltage setting in the United States, all of the individual labels marked with an asterisk mark “*” in FIG. 2 is shaded or highlighted in black or a dark color indicating intended placement on black wire, all of the individual labels marked with a pound sign “#” in FIG. 2 is shaded or highlighted in red or a reddish or pink color that indicates intended placement on red wire, and all of the individual labels marked with an exclamation mark “!” in FIG. 2 is shaded or highlighted in blue or a light blue color that indicates intended placement on blue wire. The same effect can be accomplished by simply making the entire surfaces of the labels black, red, or blue to correspond with the intended color of wire on which they will be placed and having the numbers for each label printed in a distinguishable color that contrasts with the surfaces of the labels themselves so that both the intended number and color of each wire is easily discerned. As an additional example, in a high voltage setting in the United States, all of the individual labels marked with an asterisk mark “*” in FIG. 2 has brown shading or highlighting, all of the individual labels marked with a pound sign “#” in FIG. 2 has orange shading or highlighting, and all of the individual labels marked with an exclamation mark in FIG. 2 has yellow shading or highlighting. Again, as with the low voltage examples, the surfaces of the individual labels themselves could be brown, orange, or yellow as long as the numbers printed on the labels are distinguishable from the surface of the labels themselves and both the number and color of the wire to which the labels will be adhered can be read/discerned by the user.

With reference to FIG. 2, in another embodiment of the invention, each of the labels marked with an asterisk symbol “*” is shaded, highlighted or printed in a color which is the same color as the wire on which the label will be used. Each of the labels marked with a pound sign “#” is shaded, highlighted or printed in a color which is the same color as the wire on which the label will be used. Each of the labels marked with an exclamation mark “!” is shaded, highlighted or printed in a color which is the same color as the wire on which the label will be used. For instance, in a low voltage setting in the United States, all of the individual labels marked with an asterisk mark “*” in FIG. 2 will bear their numbers and would also bear a black mark or dot indicating intended placement on black wire, all of the individual labels marked with a pound sign “#” in FIG. 2 will bear their number and a mark or dot that is red that indicates intended placement on red wire, and all of the individual labels marked with an exclamation mark “!” in FIG. 2 will bear their number and a blue mark or blue dot that indicates intended placement on blue wire. As an additional example, in a high voltage setting in the United States, all of the individual labels marked with an asterisk mark “!” in FIG. 2 will bear, for example, their numbers and will also bear a brown mark or brown dot indicating intended placement on brown wire, all of the individual labels marked with a pound sign “#” in FIG. 2 will bear, for example, their number and a mark or dot that is orange that indicates intended placement on orange wire, and all of the individual labels marked with an exclamation mark “!” in FIG. 2 will bear, for example, their number and a yellow mark or yellow dot that indicates intended placement on yellow wire.

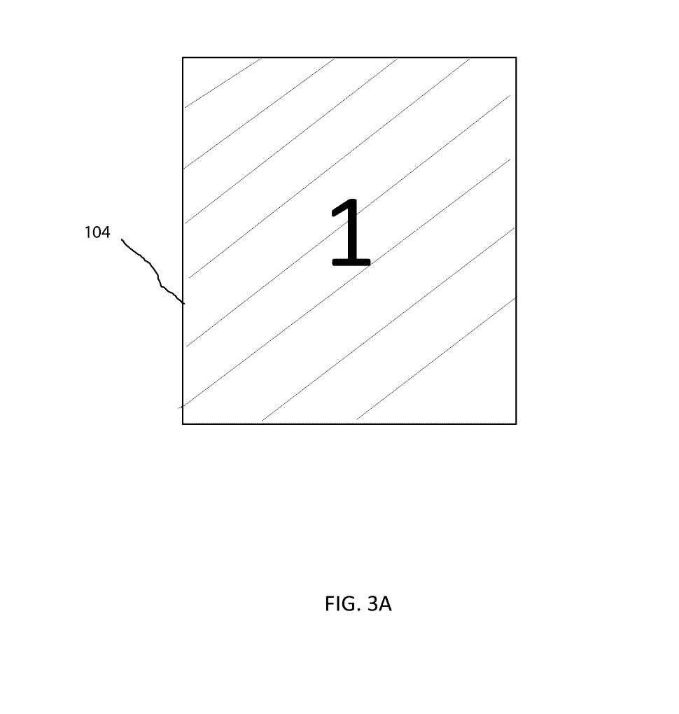

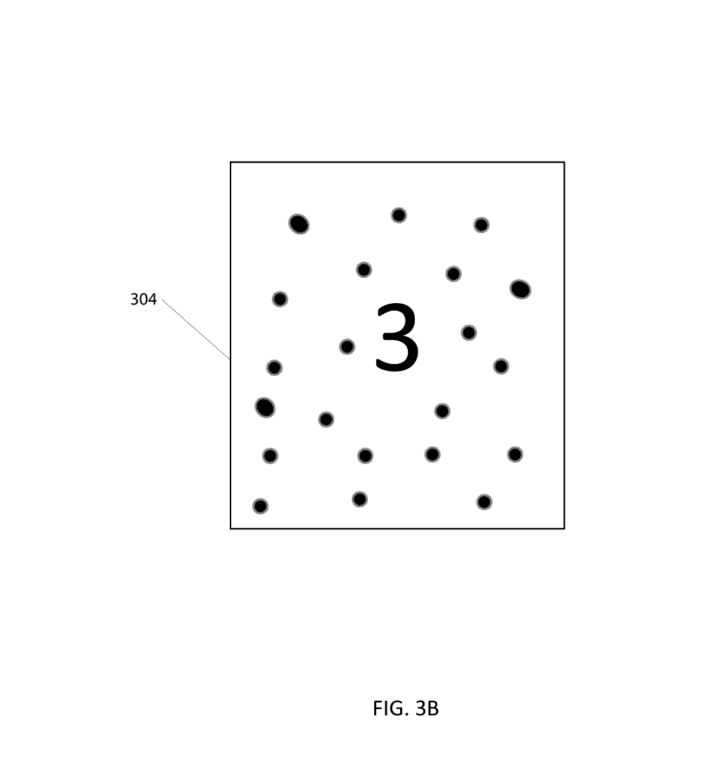

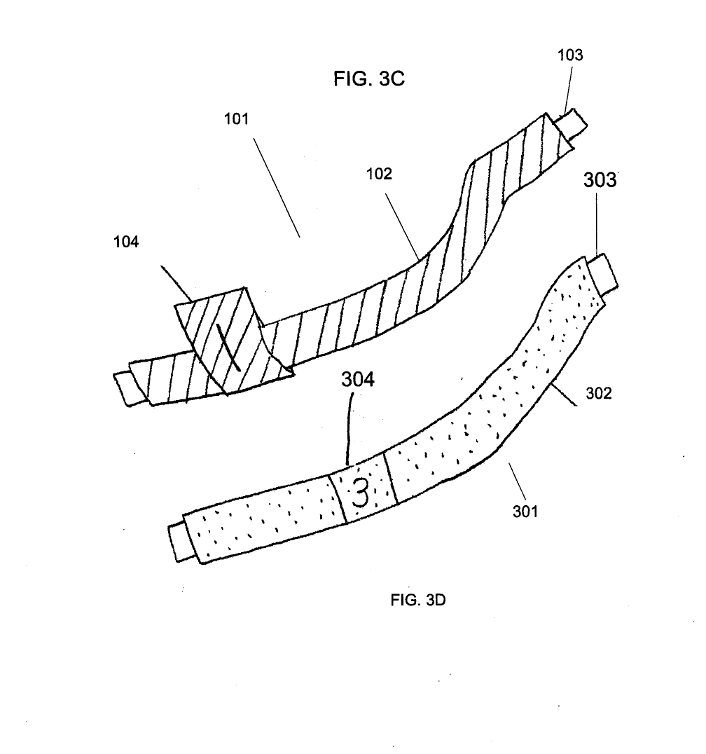

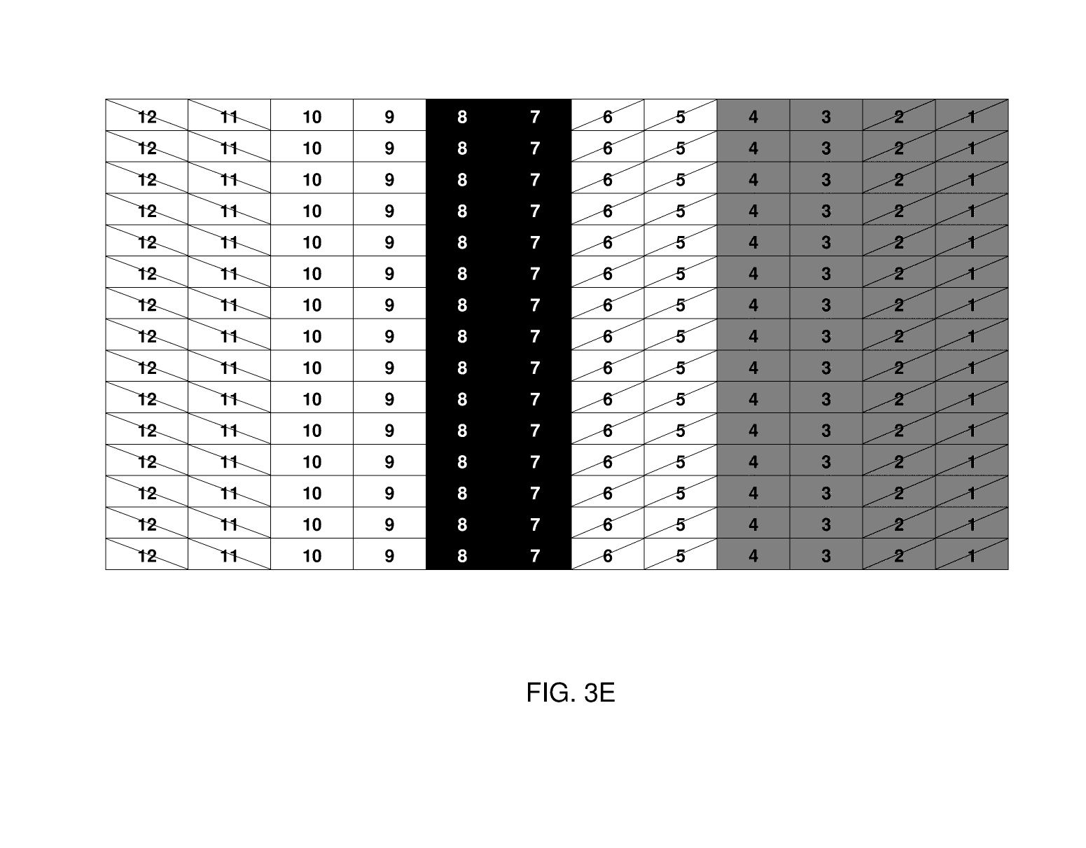

FIGS. 3C and 3D respectively illustrate two separate wires, each of which has been labeled with one of the labels of the present invention. The first wire 101 has a conductive metal core 103 and a colored insulator 102. The fact that the colored insulator 102 is colored is indicated by diagonal crosshatching drawn on its outside surface. An individual preprinted adhesive label 104 of the present invention is adhered to the outside surface of the colored insulator 102. The fact that the individual preprinted adhesive label 104 is the same color as the colored insulator 102 of the wire 101 is indicated by crosshatching on the individual preprinted adhesive label 104. FIG. 3D illustrates a second wire 301 with a second conductive metal core 303 and a second colored insulator 302. The fact that the second colored insulator 302 is colored is indicated by dots drawn on the outside surface of the second colored insulator 302. A second individual preprinted label 304 of the present invention is adhered to the outside surface of the second colored insulator 302. The fact that the second individual preprinted label 304 is the same color as the second colored insulator 302 of the second wire 301 is indicated by the dots drawn on the second individual preprinted label 304.

FIGS. 3A and 3B show the individual preprinted adhesive label 104 and the second individual preprinted adhesive label 304 previously shown in FIG. 3 at a time prior to their adhesion to wires 101 and 301. As shown by the presence of the diagonal crosshatching on preprinted adhesive label 104 and the presence of the dots on the second preprinted adhesive label 304, in some embodiments of the present invention, the labels are the same color as the wires on which the labels are intended to be placed.

It should be understood that the color of the wires is determined by the color of the insulator surrounding the conductive metal cores of the wires. It will be understood that the color of a wire is always the color of the insulator around the conductive metal core. A “wire” is comprised of a conductive metal core and an insulator.

FIG. 3E shows a different version of the sheet of preprinted adhesive labels discussed in this application. FIG. 3A shows an individual preprinted adhesive label 104 and FIG. 3B illustrates a second individual preprinted adhesive label 304 taken from the sheet shown in FIG. 3E at a time prior to their removal from the sheet of preprinted adhesive labels. FIG. 3E also is illustrative that there are multiple individual preprinted adhesive labels on a sheet of adhesive labels prior to the time that the labels are removed for placement on the wires. For sake of clarity, it should be understood that FIG. 3E shows one hundred eighty separate adhesive labels that have not yet been removed from the sheet of adhesive labels for placement on wires. All labels in each column are illustrated with uniform shading and/or cross hatching the shading or cross hatching in some embodiments will be replaced by colors corresponding to the phase for which the label will be employed. The color and/or cross hatching on the first, second, seventh, and eighth columns of labels (column position in this embodiment is read from right to left across the sheet of labels) indicates those labels will all be the same color and/or cross hatching to correspond with their intended placement on wires carrying one phase of alternating current. The third, fourth, ninth, and tenth columns of labels indicate that the labels in those columns will all be shaded, cross hatched and/or colored uniformly to correspond with the intended placement of those labels on wires carrying a second phase of alternating current. The fifth, sixth, eleventh, and twelfth columns of labels indicate that the labels in those columns will all be shaded, cross hatched and/or colored uniformly to correspond with the intended placement of those labels on wires carrying a third phase of alternating current.

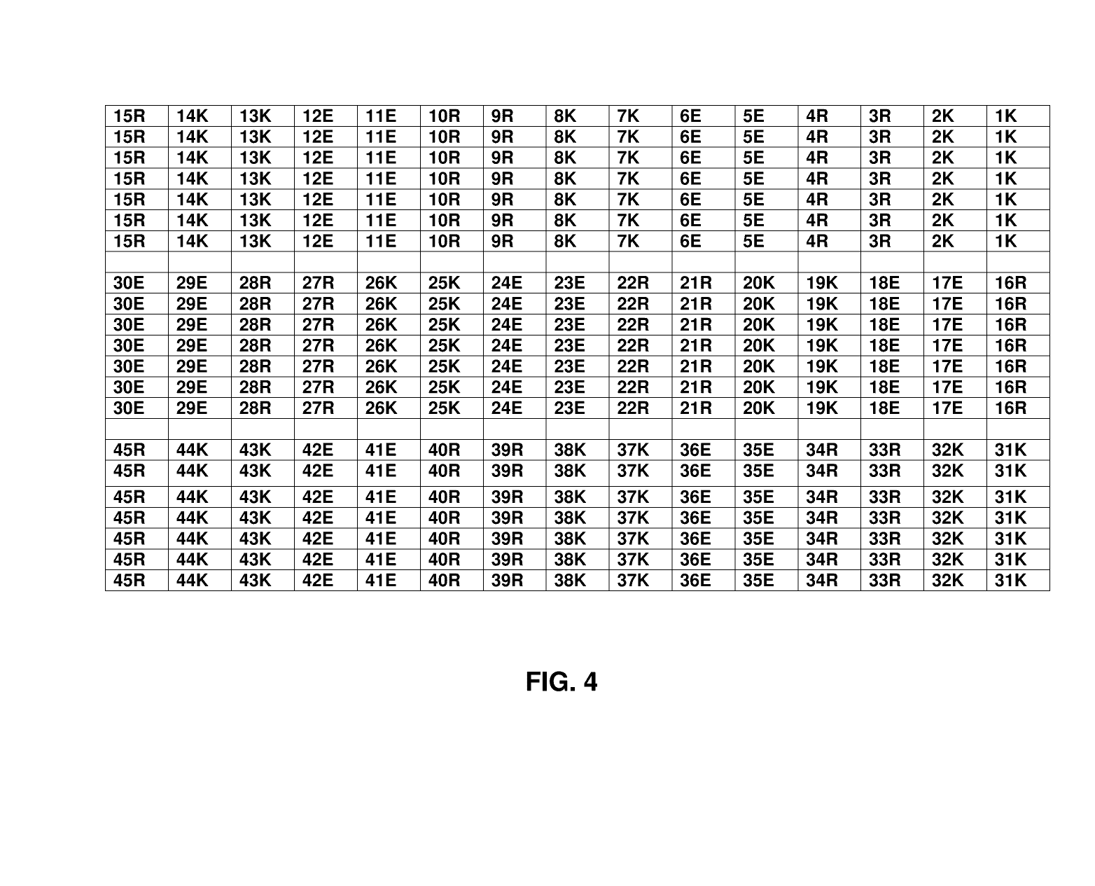

FIG. 4 shows a sheet of adhesive labels demonstrating one embodiment of the present invention for potential use on low voltage wires in the United States. Because the USPTO does not ordinarily allow color drawings in non-provisional patent applications FIG. 4 includes color codes “K” for black, “E” for blue and “R” for red corresponding to conventional low voltage color codes. FIG. 4 accordingly shows that the various labels with color codes corresponding to the color of the wires on which they are intended to be placed as labels during the process of wiring a commercial or residential building or other structure.

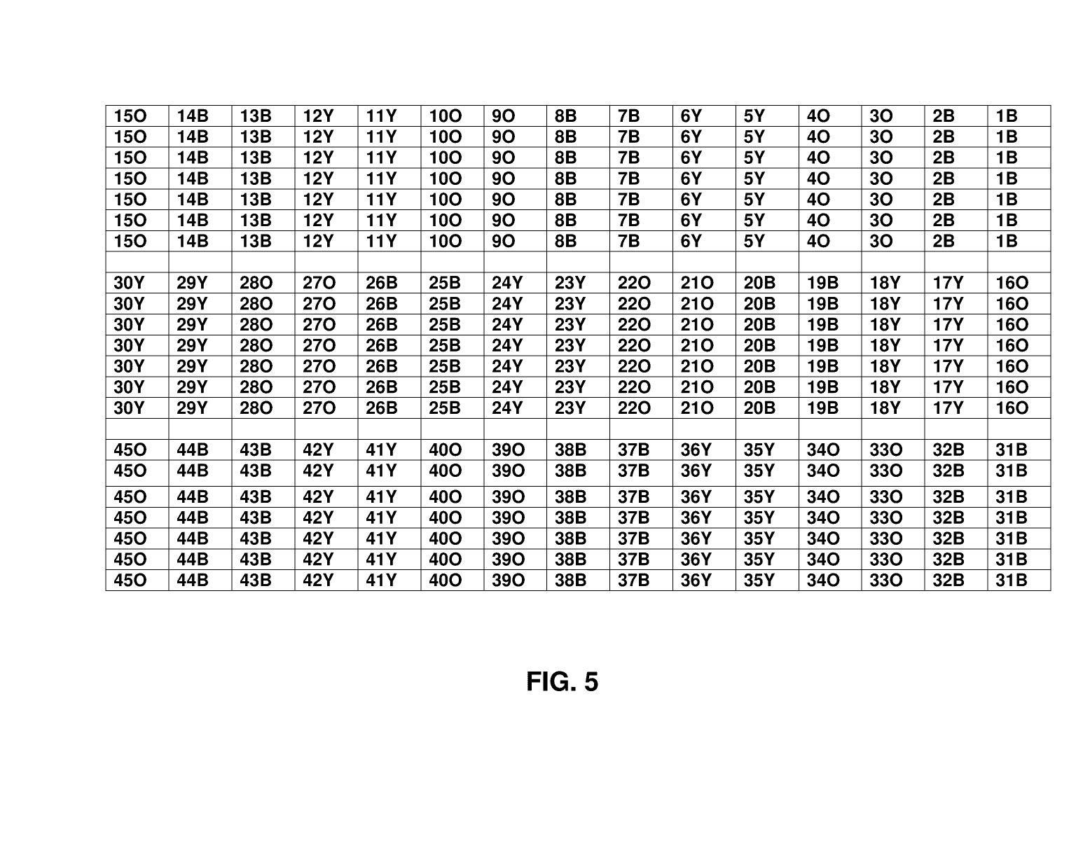

FIG. 5 shows a sheet of adhesive labels demonstrating one embodiment of the present invention for potential use on high voltage wires in the United States. Because the USPTO does not ordinarily allow color drawings in non-provisional patent applications FIG. 5 includes color codes “B” for brown, “O” for orange and “Y” for yellow corresponding to conventional high voltage color codes. FIG. 5 accordingly shows that the various labels with color codes corresponding to the color of the wires on which they are intended to be placed as labels during the process of wiring a commercial or residential building or other structure.

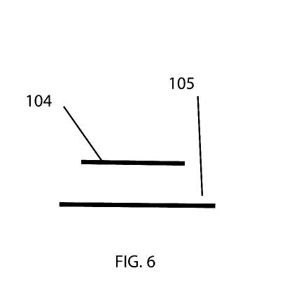

FIG. 6 illustrates the use of release paper for a label to facilitate attachment of individual labels to a wire.

In one embodiment of the invention, each of the individual adhesive labels themselves has a surface that is colored such that its color corresponds to the wire color on which the label is intended to be placed during the wiring process. The preprinted numbers on the labels must be distinguishable from the surface color of the labels themselves so that an electrician will be able to look at the label and perceive both the number of the wire corresponding to its number in a wiring plan and the color of the wire indicating the phase of power carried on that wire. Moreover, the coloring of the surface of the labels in conjunction with the numbering of the labels will aide electricians when pulling wire for making a connection because they can carry a sheet of adhesive labels with them when obtaining wire from a wire cart or wire spool and can refer to the sheet of adhesive labels itself to instantly determine the color of wire corresponding to the number of each wire.

In one embodiment of the invention, in a low voltage setting in the United States, the preprinted adhesive labels with numbers “1”, “2”, “7”, “8”, “13”, “14”, “19”, “20”, “25”, “26”, “31”, “32”, “37”, “38”, “43”, and “44” would all be black labels to correspond with intended placement on low voltage black wires.

In one embodiment of the invention, in a low voltage setting in the United States, the preprinted adhesive labels with numbers “3”, “4”, “9”, “10”, “15”, “16”, “21”, “22”, “27”, “28”, “33”, “34”, “39”, “40”, and “45” will all be red labels to correspond with intended placement on low voltage red wires.

In one embodiment of the invention, in a low voltage setting in the United States, the preprinted adhesive labels with numbers “5”, “6”, “11”, “12”, “17”, “18”, “23”, “24”, “29”, “30”, “35”, “36”, “41”, and “42” would all be blue labels to correspond with intended placement on low voltage blue wires.

In one embodiment of the invention, in a high voltage setting in the United States, the preprinted adhesive labels with numbers “I”, “2”, “7”, “8”, “13”, “14”, “19”, “20”, “25”, “26”, “31”, “32”, “37”, “38”, “43”, and “44” would all be brown labels to correspond with intended placement on high voltage brown wires.

In one embodiment of the invention, in a high voltage setting in the United States, the preprinted adhesive labels with numbers “3”, “4”, “9”, “10”, “15”, “16”, “21”, “22”, “27”, “28”, “33”, “34”, “39”, “40”, and “45” would all be orange labels to correspond with intended placement on high voltage orange wires.

In one embodiment of the invention, in a high voltage setting in the United States, the preprinted adhesive labels with numbers “5”, “6”, “11”, “12”, “17”, “18”, “23”, “24”, “29”, “30”, “35”, “36”, “41”, and “42” would all be yellow labels to correspond with intended placement on high voltage yellow wires.

In one embodiment of the invention, the number printed on the surface of each of the individual adhesive labels is printed in a color that corresponds to the wire color on which the label is intended to be placed during the wiring process. The preprinted numbers on the individual labels must be printed in a color corresponding to the color of the wire on which the labels are intended to be placed that designates the phase of power carried by the wire such that an electrician will be able to look at the label and perceive both the number of the wire corresponding to the number of the wire in the plan and the color of the wire indicating the phase of power carried on the wire. Moreover, printing the number on the labels in the same color as the wire on which the labels will be used will aide electricians when pulling wire for making a connection because they can carry a sheet of adhesive labels with them when obtaining wire from a wire cart or wire spool and can refer to the sheet of adhesive labels itself to instantly determine the color of wire corresponding to the number of each wire.

In one embodiment of the invention, in a low voltage setting in the United States, the preprinted adhesive labels with numbers “1”, “2”, “7”, “8”, “13”, “14”, “19”, “20”, “25”, “26”, “31”, “32”, “37”, “38”, “43”, and “44” has the numbers printed on the labels in black to correspond with intended placement on low voltage black wires.

In one embodiment of the invention, in a low voltage setting in the United States, the preprinted adhesive labels with numbers “3”, “4”, “9”, “10”, 15”, “16”, “21”, “22”, “27”, “28”, “33”, “34”, “39”, “40”, and “45” has the numbers on the labels printed in red to correspond with intended placement on low voltage red wires.

In one embodiment of the invention, in a low voltage setting in the United States, the preprinted adhesive labels with numbers “5”, “6”, “11”, “12”, “17”, “18”, “23”, “24”, “29”, “30”, “35”, “36”, “41”, and “42” has the numbers on the labels printed in blue to correspond with intended placement on low voltage blue wires.

In one embodiment of the invention, in a high voltage setting in the United States, the preprinted adhesive labels with numbers “1”, “2”, “7”, “8”, “13”, “14”, “19”, “20”, “25”, “26”, “31”, “32”, “37”, “38”, “43”, and “44” has the numbers on the labels printed in brown to correspond with intended placement on high voltage brown wires.

In one embodiment of the invention, in a high voltage setting in the United States, the preprinted adhesive labels with numbers “3”, “4”, “9”, “10”, “15”, “16”, “21”, “22”, “27”, “28”, “33”, “34”, “39”, “40”, and “45” has the numbers on the labels printed in orange to correspond with intended placement on high voltage orange wires.

In one embodiment of the invention, in a high voltage setting in the United States, the preprinted adhesive labels with numbers “5”, “6”, “11”, “12”, “17”, “18”, “23”, “24”, “29”, “30”, “35”, “36”, “41”, and “42” has the numbers on the labels printed in yellow to correspond with intended placement on high voltage yellow wires.

In one embodiment of the invention, in addition to the number printed on the surface of each of the individual adhesive labels, each adhesive label would also contain a mark or dot printed in a color that corresponds to the wire color of the wire on which the label is intended to be placed during the wiring process. In this embodiment, the mark or dot on each individual label must be printed in a color corresponding to the wire on which the label is intended to be used such that an electrician will be able to look at the label and perceive both the number of the wire and the color of the wire indicating the phase of power carried on that wire. Moreover, printing a mark or dot on the labels in the same color as the wire on which the labels will be used will aide electricians when pulling wire for making a connection because they can carry a sheet of adhesive labels with them when obtaining wire from a wire cart or wire spool and can refer to the sheet of adhesive labels itself to instantly determine the color of wire corresponding to the number of each wire.

In one embodiment of the invention, in a low voltage setting in the United States, the preprinted adhesive labels with numbers “1”, “2”, “7”, “8”, “13”, “14”, “19”, “20”, “25”, “26”, “31”, “32”, “37”, “38”, “43”, and “44” has a black mark or black dot printed on the labels to correspond with intended placement on low voltage black wires.

In one embodiment of the invention, in a low voltage setting in the United States, the preprinted adhesive labels with numbers “3”, “4”, “9”, “10”, “15”, “16”, “21”, “22”, “27”, “28”, “33”, “34”, “39”, “40”, and “45” has a red mark or red dot printed on the labels to correspond with intended placement on low voltage red wires.

In one embodiment of the invention, in a low voltage setting in the United States, the preprinted adhesive labels with numbers “5”, “6”, “11”, “12”, “17”, “18”, “23”, “24”, “29”, “30”, “35”, “36”, “41”, and “42” has a blue mark or blue dot printed on the labels to correspond with intended placement on low voltage blue wires.

In one embodiment of the invention, in a high voltage setting in the United States, the preprinted adhesive labels with numbers “1”, “2”, “7”, “8”, “13”, “14”, “19”, “20”, “25”, “26”, “31”, “32”, “37”, “38”, “43”, and “44” has a brown mark or brown dot printed on the labels to correspond with intended placement on high voltage brown wires.

In one embodiment of the invention, in a high voltage setting in the United States, the preprinted adhesive labels with numbers “3”, “4”, “9”, “10”, “15”, “16”, “21”, “22”, “27”, “28”, “33”, “34”, “39”, “40”, and “45” will have an orange mark or orange dot printed on the labels to correspond with intended placement on high voltage orange wires.

In one embodiment of the invention, in a high voltage setting in the United States, the preprinted adhesive labels with numbers “5”, “6”, “11”, “12”, “17”, “18”, “23”, “24”, “29”, “30”, “35”, “36”, “41”, and “42” has a yellow mark or yellow dot printed on the labels to correspond with intended placement on high voltage yellow wires.

Although, the description herein has focused on embodiments for 3 phase systems having wire numbers 1-45 persons skilled in the art will understand that the present invention includes analogous procedures for wire numbers 46-90. Other embodiments of the present invention are utilized in single phase wiring.

It should be understood that the above-described embodiments of the invention are not intended to limit the scope of the invention, but merely to illustrate specific embodiments of the improved wire labels and wire label chart as envisioned by the inventor at the time of filing this provisional application. The inventor envisions that addition of color to electricians' wire labels corresponding to the color of the wires on which the wire labels are intended to be placed will greatly facilitate the accurate and efficient wiring of commercial and residential buildings and other structures and will obviate mistakes.

All publications and patent applications mentioned in this specification are indicative of the level of skill of those skilled in the art to which this invention pertains. All such publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A system for marking a plurality of wires connected to a 3 phase electric distribution system that includes a plurality of preprinted self-adhesive labels for use on electrical wires wherein each of the labels in said plurality of labels bears one of first, second and third unique indicia and a preprinted unique integer number.

2. The system as described in claim 1 wherein said 3 phase electric distribution system is a low voltage system and said preprinted adhesive labels include respective preprinted unique integer numbers “1”, “2”, “7”, “8”, “13”, “14”, “19”, “20”, “25”, “26”, “31”, “32”, “37”, “38”, “43”, and “44” and said unique indicia is black.

3. The system as described in claim 1 wherein said 3 phase electric distribution system is a low voltage system and said preprinted adhesive labels include respective preprinted unique integer numbers “3”, “4”, “9”, “10”, “15”, “16”, “21”, “22”, “27”, “28”, “33”, “34”, “39”, “40”, and “45” and said unique indicia is red.

4. The system as described in claim 1 wherein said 3 phase electric distribution system is a low voltage system and said preprinted adhesive labels include respective preprinted unique integer numbers “5”, “6”, “11”, “12”, “17”, “18”, “23”, “24”, “29”, “30”, “35”, “36”, “41”, and “42” and said unique indicia is blue.

5. The system as described in claim 1 wherein said 3 phase electric distribution system is a high voltage system and said preprinted adhesive labels include respective preprinted unique integer numbers “1”, “2”, “7”, “8”, “13”, “14”, “19”, “20”, “25”, “26”, “31”, “32”, “37”, “38”, “43”, and “44” and said unique indicia is brown.

6. The system as described in claim 1 wherein said 3 phase electric distribution system is a high voltage system and said preprinted adhesive labels include respective preprinted unique integer numbers “3”, “4”, “9”, “10”, “15”, “16”, “21”, “22”, “27”, “28”, “33”, “34”, “39”, “40”, and “45” will and said unique indicia is orange.

7. The system as described in claim 1 wherein said 3 phase electric distribution system is a high voltage system and said preprinted adhesive labels include respective preprinted unique integer numbers “5”, “6”, “11”, “12”, “17”, “18”, “23”, “24”, “29”, “30”, “35”, “36”, “41”, and “42” and said unique indicia is yellow.

8. The system as described in claim 1 wherein said 3 phase electric distribution system is a low voltage system and
said preprinted adhesive labels include respective preprinted unique integer numbers “1”, “2”, “7”, “8”, “13”, “14”, “19”, “20”, “25”, “26”, “31”, “32”, “37”, “38”, “43”, and “44” and said unique indicia is black and
and said preprinted adhesive labels include respective preprinted unique integer numbers “3”, “4”, “9”, “10”, “15”, “16”, “21”, “22”, “27”, “28”, “33”, “34”, “39”, “40”, and “45” and said unique indicia is red and
and said preprinted adhesive labels include respective preprinted unique integer numbers “5”, “6”, “11”, “12”, “17”, “18”, “23”, “24”, “29”, “30”, “35”, “36”, “41”, and “42” and said unique indicia is blue.

9. A method for distinguishing between multiple wires carrying three-phase power in which the wires carrying power come in three separate colors that distinguish between the three separate phases of power that will be carried on the wires and adhesive labels bearing numbers printed in the same colors as the wires to which they are to be affixed are used to label the wires in order to keep track of each wire by number in relation to its connection to the main fuse box and also in order to distinguish between the phases of power.

10. A method for tracking multiple wires in a three-phase power system in which the colored wires used in a three-phase system are labeled with preprinted adhesive labels that bear a number corresponding to the number of the wire reflected in a wiring plan and each of the adhesive labels also comes pre-marked with the color of the wire to which it will be affixed.
